(19) United States
(12) Patent Application Publication
(10) Pub. No.: US 2025/0179919 A1
(43) Pub. Date: Jun. 5, 2025

(54) Ultra-efficient bladeless turbomachinery

(71) Applicants: Università degli Studi di Genova, Genova (IT); SIT Technologies Srl, Genova (IT)

(72) Inventors: Avinash Renuke, Genova (IT); Alberto Traverso, Genova (IT); Matteo Pascenti, Genova (IT); Paolo Silvestri, Genova (IT); Federico Reggio, Genova (IT)

(21) Appl. No.: 18/843,254

(22) PCT Filed: Feb. 21, 2023
(86) PCT No.: PCT/IB2023/051558

§ 371 Date: Sep. 1, 2024

(30) Foreign Application Priority Data
Mar. 9, 2022 (IT) 102022000004460

(51) Int. Cl. F01D 1/30; F01D 1/34; F04D 5/00

(52) U.S. Cl. CPC F01D 1/30; F01D 1/34; F04D 5/001

(57) ABSTRACT

A reversible turbomachine includes a rotor housing containing one or more rotor members, the rotor having a plurality of mutually spaced discs, which rotate about a rotational axis and are coaxially disposed about a rotational shaft; a primary stage for the flow of a high energy fluid, communicating with the rotor housing via at least one stator channel; a secondary stage for the flow of a low energy fluid; and at least one rotary distribution chamber for distributing the fluid to or from the rotor, the rotary distribution chamber being arranged in the internal space of the rotor housing and interposed between the at least one stator channel and at least part of the discs, the rotating distribution chamber having at least one rotor opening for the passage of the fluid between the primary stage and the rotor.

The present invention relates to dynamic machines typically called turbomachines used to exchange work with fluids, fluids whose pressure and/or speed is modified. Such work exchange is typically performed with volumetric or dynamic machines. More particularly, the invention relates to the type of bladeless turbomachine, also called boundary layer/multiple-disc/Tesla turbomachine. Application examples are turbines/expanders, compressors, pumps/aspirators, operating with a variety of fluids, such as water, air, gas or gas mixtures, non-Newtonian fluids, two-phase fluids.

The “boundary layer disk turbine” also named “Tesla turbine (U.S. Pat. Nos. 1,061,206A and 1,061,142A)”, “multiple disk turbine”, “bladeless turbine”, “Prandtl layer turbine” was invented by Nikola Tesla in the early 19th century. The rotor comprises thin discs with a central hole, mounted parallel on a shaft and spaced by gaps while the stator is positioned at a greater radial distance than the rotor and guides the flow in the desired direction. The periphery of the stator is connected to an external volute. In turbine mode, the fluid at higher pressure enters the volute and then into the stator, which accelerates it tangentially to the rotor and exits the axially central holes of the rotor at lower pressure. In compressor mode, the lower pressure fluid enters the central holes of the discs and exits the rotor with higher pressure from the periphery of the discs. The peripheral fluid at high speed increases its static pressure through the stator and finally using an external volute. Thus, this machine is reversible: by changing the direction of rotation of the rotor, both modes, turbine and compressor, can be achieved using the same single machine with minor or no modifications to the configuration of the machine itself. The relative speed between the fluid and the rotor discs is very low compared to traditional bladed turbines. Due to this low airspeed, the flow inside the rotor is substantially laminar. The laminar flow field within the Tesla turbine rotor is the key to effective energy transfer between fluid and disks. This energy exchange between the fluid layers and the disks is due to the tangential force. The drag force generated on the discs due to these tangential forces lies in the plane of rotation of the discs. Hence, in the case of the Tesla turbine, the viscous shear resistance is favorable and necessary for the generation of mechanical energy unlike an energy loss in the case of a bladed turbine where the viscous resistance dissipates mechanical energy as it is in the opposite direction to the rotation of the rotor. This interesting phenomenon has attracted many researchers to study bladeless turbines.

Tesla claimed to be able to achieve very high rotor efficiency (up to 97%). This has also been demonstrated analytically by researchers. However, experimentally the complete efficiency of the Tesla turbine (including a stator fluid dynamically coupled to the rotor) is typically very low (<35%) (Table 1—the reported efficiencies are of the isentropic adiabatic type). This lower efficiency of the Tesla turbine compared to conventional bladed turbomachinery has been a major reason why the former has not been commercially successful thus far. Table 1 shows the main scientific publications since 1950 with experimental efficiencies obtained by various researchers with different working fluids. It can be noted that the maximum efficiency obtained with air as working fluid is less than 35%. The last row shows the prototypes of a Tesla turbine tested at TPG-DIME, UNIGE (Thermochemical Power Group, Department of Mechanical, Energy, Management and Transport Engineering, University of Genoa, Italy). The efficiency of the Tesla turbine with air as working fluid of about 36% (highest recorded so far) has been demonstrated experimentally.

TABLE 1

| | | Inlet | Mass | | | | |
|---|---|---|---|---|---|---|---|
| | | pressure | flow | | | | Efficiency |
| Author | Fluid | (barg) | (g/s) | RPM | Power | | (%) |
| Tesla | Steam | 8.62 (dry sat) | 957 | 9000 | 147 | kW | 46.6 |
| Amstrong, 1952 | Steam | 6.89 | | 6000 | 382.5 | W | [—] |
| | | 6.89 | [—] | 5500 | 382.5 | W | [—] |
| | | 8.14 | | 8300 | 816.4 | W | [—] |
| Muhlstein et al | Air | 4.14 | 16.6 | 19000 | 183.9 | W | 9.99 |
| (Beans, 1961) | | 1.38 | 4.85 | 6430 | 33.8 | W | 11.1 |
| Beans, 1961 | Air | [—] | [—] | [—] | [—] | | 23.5 |
| Rice, 1965 | Air | 8.62 | 36.4 | 10000 | 1235.6 | W | 23.2 |
| | | 2.76 | 21.31 | 9200 | 625.2 | W | 25.8 |
| | | 5.15 | [—] | 17200 | 2942 | W | 34.8 |
| Bloudíček, P., | Water | [—] | [—] | [—] | [—] | | 54.9 |
| and Paloušek, | | | | | | | |
| 2007 | | | | | | | |
| Guha, 2010 | Air | 2.9 | [—] | 25000 | 140 | W | 25 |
| Krishnan, 2011 | water | 0.15 | 8 | 5590 | 20.3 | mW | 18.4 |
| | | 0.13 | 8 | 5264 | 19.8 | mW | 19.7 |
| | | 0.19 | 10 | 6522 | 16.9 | mW | 9.3 |
| | | 0.01 | 2 | 1243 | 0.4 | mW | 36.6 |
| | | 0.01 | 2 | 689 | 0.32 | mW | 27 |
| | | 0.06 | 5 | 3488 | 0.87 | mW | 22 |
| Peshlakai, 2012 | Air | [—] | 5.5 | 3600 | 6 | W | 31.17 |
| Holland, 2015 | Air | 3 | [—] | 10000 | [—] | | 8.5 |
| Li et al, 2017 | Air | 2.6 | 390 | 900 | [—] | | 8 |
| Rusin, 2018 | Air | 3 | [—] | 20500 | 42.5 | W | 8.4 |
| Renuke, 2019 | Air | 1.6 | 7.7 | 40000 | 146 | W | 18 |
| Renuke, 2020 | Air | 2.4 | 24.7 | 10000 | 146 | W | 36.5 |

The table also shows that the Tesla turbine has been tested with different fluids: steam, air, water, organic fluids (refrigerant—mono/two-phase), etc.

The advantages of the Tesla turbine such as resistance to erosion, flow reversibility, simple and economical construction and flexibility in the choice of fluid make it suitable for both energy recovery and small scale power generation applications. Recently, a renewed interest in Tesla machines is clearly emerging. It should be noted that the trend has drastically increased in recent years; this is directly related to the high attention that micro-generation of energy has gained on the energy market, where Tesla turbines have interesting characteristics, mainly due to their high cost-effectiveness and relatively simple manufacture. However, there are still no unique criteria for the design of Tesla machinery and many authors and professionals work on very small prototypes (˜100-1000 Watt scale), where manufacturing tolerances and uncertainties in losses impede the accuracy of the experimentation.

A systematic study oriented towards the development of efficient and well-designed Tesla machines, having powers of the order of at least kW, is therefore necessary to exploit their potential to become one of the players in turbo-machine technologies, where their features are competitive or more promising than other conventional machines.

Consequently, it is necessary to improve this type of devices in order to improve the overall efficiency while maintaining or improving the constructive simplicity and operating costs, for different sizes of turbomachinery.

The authors of this patent specification studied and performed a detailed leakage analysis of a prototype 3 kW Tesla turbomachinery, which achieved the aforementioned record efficiency of approximately 36% for bladeless air expanders. Through a detailed experimental characterization it was possible to identify, for the first time, the main sources of losses, namely:
i) stator-rotor interaction;
ii) losses due to fluid leakage around the rotor;
iii) other losses such as ventilation losses.

The present application proposes an innovative solution to both aspects: for the first, which represents an intrinsic loss already present in Tesla's first patent in 1913 and concerning all subsequent designs and worldwide realizations to date, and for the second, which affects many of the prototypes built by researchers.

The present invention relates to specific improvements in bladeless turbomachinery for power generation, energy recovery, compressor/booster, for producing mechanical power to drive mechanical/electrical/magnetic load applications. The working fluid can be single-phase and/or two-phase and/or multi-phase. This turbomachine can be used in a variety of applications, some of which are (but are not limited to) solar energy, hydrogen, natural gas, cryogenics, petrochemicals, power generation, supercritical carbon dioxide cycle, geothermal energy, Rankine cycle Organic, refrigeration, air conditioning and heat pumps, pressure reducing valve replacement for energy recovery, oil and gas applications and hydroelectric power.

From the intimate understanding of the stator-rotor losses phenomenon, the main innovation object of this patent application has arisen, which is able to considerably reduce this significant efficiency loss mechanism.

In fact, one of the reasons why bladeless turbomachinery has not been commercially successful is the low experimental efficiency. This is due to the need for a highly tangential flow at the rotor inlet. The present invention significantly reduces stator-rotor losses by providing less surface area exposed to tangential flow in the stator-rotor region. This invention improves the performance of the bladeless turbine/compressor to the level of conventional bladed machines, making it compete with conventional machines not only on a smaller scale (where bladed machines experience high losses, unlike non-blade machines) but also on a large scale. The innovation described in the present invention identified for the purpose of reducing the stator-rotor interaction losses also allows to define special sealing measures, to also reduce the second main cause of losses, i.e. leakage losses, up to a few percentage points. In addition, additional features have been included, relating to ways to reduce exhaust losses.

The invention achieves the predetermined objects and others by means of a reversible bladeless turbomachine i.e. capable of operating in turbine mode for the transfer of the energy of at least one fluid into mechanical energy or capable of operating in compressor mode for the transfer of mechanical energy in energy of a fluid, said turbomachine comprising:
a rotor housing containing one or more rotor members which rotor comprises a plurality of mutually spaced discs which rotate about a rotational axis and are coaxially disposed about a rotational shaft;
a primary stage for the transit of the high energy fluid, communicating with the rotor housing by means of at least one stator channel;
a secondary stage for the transit of the low energy fluid;
which turbomachine comprises at least one rotary distribution chamber for distributing said fluid to or from the rotor, said rotary distribution chamber being arranged in the internal space of the stator housing and interposed between the at least one stator channel and at least part of said discs forming part of the rotor, in particular between the radial periphery of the rotor and the internal surface of the stator, said rotating distribution chamber being provided with at least one rotor opening for the passage of the fluid between the primary stage and the rotor.

Since, as mentioned, this machine is able to operate in turbine mode or in compressor mode, where possible reference will be made to the concept of the primary stage in which a fluid with high kinetic energy flows and to the concept of a secondary stage in which low energy fluid flows, where high and low energy are considered in mutually relative terms.

In this situation, a compressor turbomachine will have inlet fluid in the low energy stage and outlet fluid in the high energy stage precisely by virtue of the function of transferring mechanical energy from the shaft to increase the energy of the fluid.

Conversely, turbine operation will have high-energy fluid at the input and low-energy fluid at the output, being designed to transfer part of its energy to the rotating shaft.

As better described below and also in the embodiments of the figures, the invention solves the technical problem of increasing the efficiency of a Tesla type turbine by introducing a rotating distribution chamber interposed between the radial periphery of the rotor and the internal surface of the stator, which rotating chamber favors the distribution of the fluid between stator nozzles and rotor discs.

From the studies carried out by the Applicant it emerged that the configuration with a single stator channel brings benefits in terms of reduction of ventilation losses; however the invention foresees, in its variants, that it is possible to have two or more stator channels also according to the design characteristics of the turbomachine chosen by the person skilled in the art.

In one embodiment, said rotating distribution chamber is arranged coaxially with the discs and rotates at the same angular speed as said discs. In this preferred embodiment, the rotating distribution chamber is at least partially made by means of rotating discs with a specific shape (some embodiments will be described below) which can be made fixed with the shaft and therefore rotate at the same speed as the stator discs, thus defining portions of the surfaces that delimit the distribution chamber.

In one embodiment, said rotary distribution chamber is delimited by at least one chamber wall which radially and at least partially surrounds the rotor, said chamber wall being formed by at least part of the radially inner surface of at least one distribution member which it rotates coaxially with the rotation shaft, preferably at the same angular velocity as the disks.

Conventionally and also according to the present invention, the rotor of the bladeless turbomachine comprises a plurality of thin discs having similar or mutually different external and/or internal diameters with gaps between them (reciprocally spaced by a constant or variable distance between disk and disk) connected to a tree, creating a set of disks.

As regards the reduction of stator-rotor losses, there are two preferred embodiments: one for the traditional radial stator configuration and one for an innovative axial stator configuration.

When operating as a turbine mode, regarding the radial stator, the flow is accelerated through a radial stator and directed to the rotor spaces, where the flow travels and exchanges energy, from the peripheral inlet of the disc to the internal discharge of the disc. Unlike conventional Tesla machines, where the radial passages of the stator placed on the periphery of the rotating disks have an axial dimension close to the set of rotor disks, here the stator has a reduced axial dimension, for example half, and the jets stators are not directed immediately towards the rotating discs, but first enter a rotating “distribution chamber”. In a possible embodiment, this chamber comprises two rotary shaped discs (RSD), symmetrically or asymmetrically mounted on a shaft, which are shaped in such a way as to form a rotating radial passage to guide the fluid from the stator to the rotating discs. In this way there is a significant radial distance, for example 10% of the peripheral radius of the disc, between the stator and the set of rotating discs: consequently the friction between the set of rotating discs and the stator or casing is minimized, reducing friction losses between rotor and stator. A similar principle applies to the distribution chamber formed by the rotating pattern discs (RSD) in compressor mode.

As far as the axial stator is concerned, the stator comprises a radial/axial blade for the transit of the fluid having a high tangential speed, placed in communication with a rotating distribution chamber, which in a possible embodiment comprises one or two shaped rotating discs (RSD), symmetrically or asymmetrically mounted on a shaft, shaped so as to form an axial opening for the passage of fluid from/to the stator, and directing it towards/from the rotating discs. Furthermore, in this way, the friction losses between the rotor and the stator or casing are minimized, reducing the friction losses between the rotor and the stator.

The above configurations, in particular the rotating distribution chamber, are designed in such a way that the same device can operate, with little or no configuration changes, alternatively in turbine mode or in compressor mode depending on the direction of the fluid flow, which can be used to transfer energy to rotating discs (turbine mode) or which can be accelerated by discs which transfer mechanical energy from the shaft into kinetic energy to the fluid (compressor mode).

For various embodiments, in case a high axial length of the rotor (i.e. a large number of disks) is required, to ensure a smooth and well guided inlet flow to the rotating chamber and rotor (with reference to the turbine operating mode), it is possible to insert a flow divider or an intermediate disc/s, one or two or more than two, on the periphery of the rotor, and use it in combination with one or more of the other embodiments. The introduction of these embodiments of the present invention into the bladeless turbomachinery significantly improves the efficiency of the turbine or compressor.

In addition to minimizing stator-to-rotor losses, i.e., at the rotor inlet for turbine operation, this invention also includes ways of reducing losses at the rotor exhaust (turbine mode) or rotor inlet (compressor mode).

In a preferred variant of the invention, with reference to operation as a turbine, the rotor is then connected to an exhaust system to recover at least part of the residual kinetic energy of the outgoing fluid. When operating in compressor mode, the same system can function as a first stage of acceleration for the fluid which will then be accelerated by the main stage of acceleration, i.e. the rotor discs. The turbine exhaust system is preferably provided with a radial diffuser which is further connected to the volute(s) known in the art. The turbine of the present invention may have one axial exhaust or two axial exhausts.

Unlike many inventors who have tried to improve the performance of Tesla turbomachinery by introducing complex features on the discs themselves, increasing the complexity of the original Tesla bladeless design, this invention only adds simple external features to the original turbomachinery. Tesla without shovels. These features are simple to manufacture and simple to implement without introducing further complexities into the original bladeless design.

It is foreseen that, by applying both the conventional sealing devices and the solutions of this invention to the existing prototype, the peak isentropic adiabatic efficiency can be increased from 36% to over 70%, approaching the expected efficiency for the rotor alone, typically in the order of 80%-90% (as noted above, in conventional Tesla machines rotor alone efficiency is greatly affected by stator-to-rotor losses, which can more than half efficiency of the rotor alone).

Nomenclature: to facilitate understanding of the invention, the following terms are defined: Bladeless Turbomachinery—BTM, Bladeless Turbine—BT, Bladeless Compressor—BC.

The present invention discloses an improvement in the BTM—turbine and compressor or the like. However, the various embodiments of the present inventions can be used in combination with any known BTM design.

Some embodiments of the invention are described below according to the accompanying drawings, where:

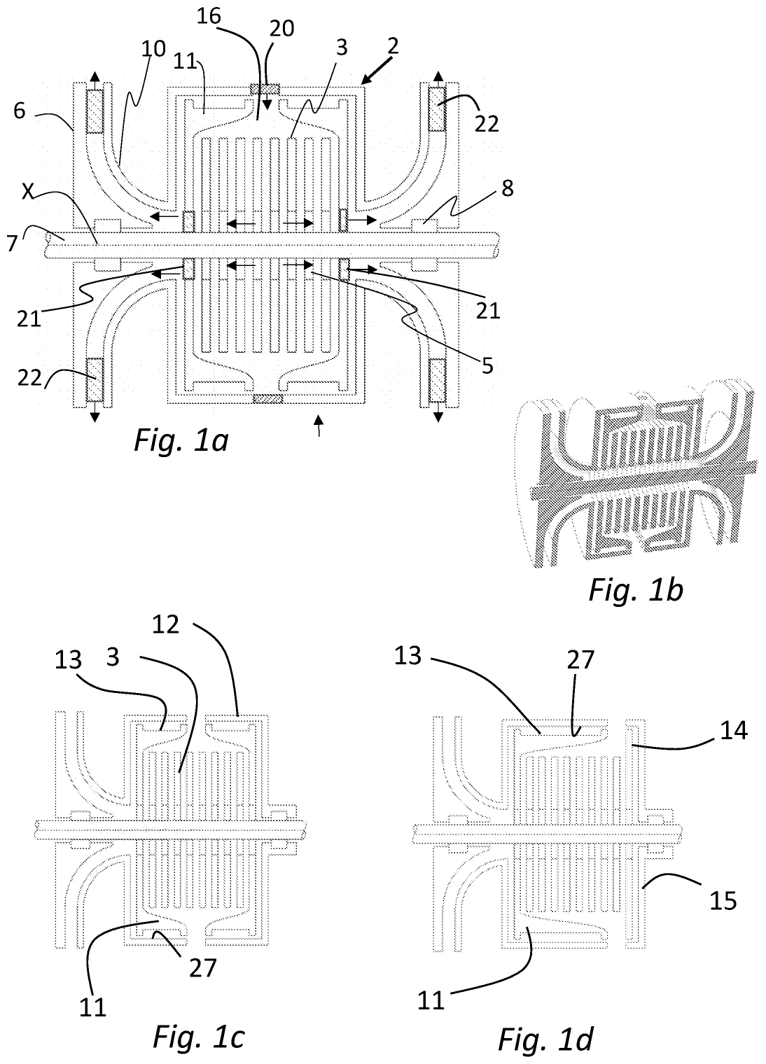

FIG. 1a and FIG. 1b show a sectional view of a Tesla turbine according to the invention, respectively in a 2D front view and in a three-dimensional view;

FIGS. 1c and 1d show front views 2D of two different embodiments with discharge port only on one side of the turbine;

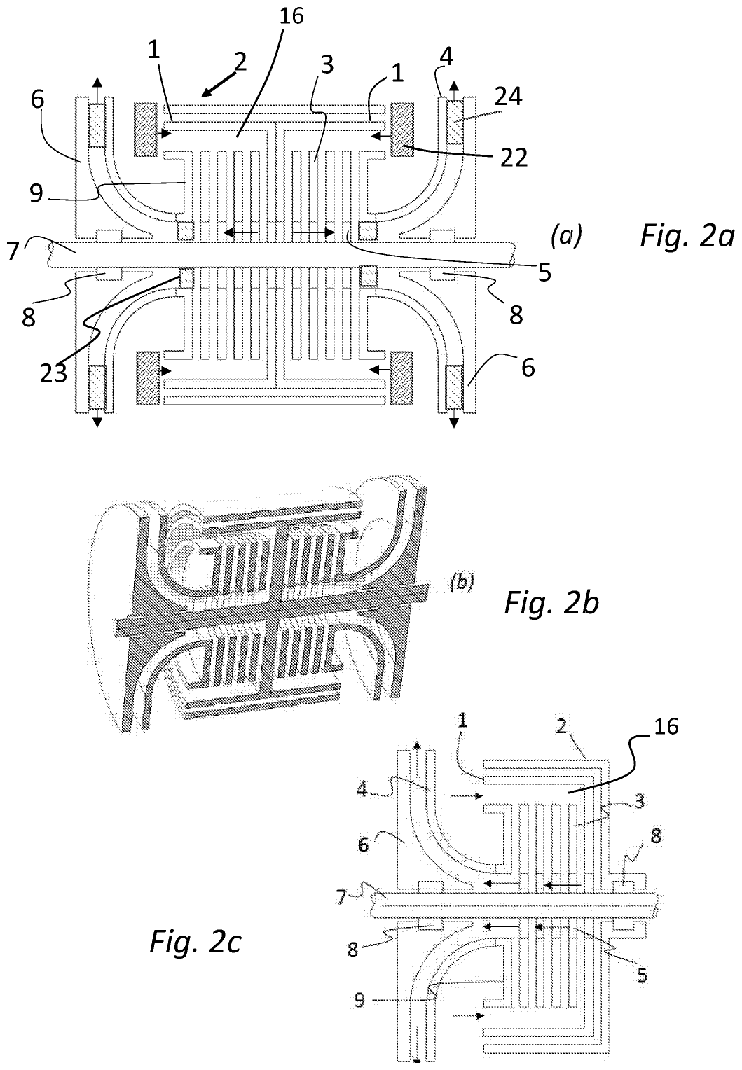

FIGS. 2a, 2b and 2c show a variant of FIGS. 1a, 1b and 1c arranged to have an axial fluid inlet;

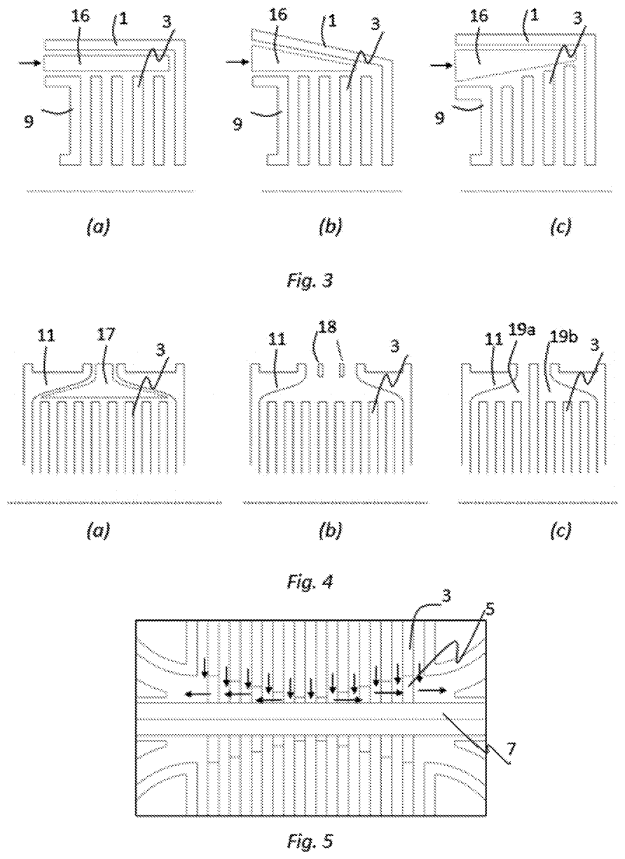

FIGS. 3a, 3b, 3c show a detail of a possible sectional view of the rotating turbulence chamber;

FIGS. 4b and 4c show variants of the configuration of FIG. 1 in which flow dividers are included;

FIG. 5 shows the details of an embodiment with variable opening of the central discs;

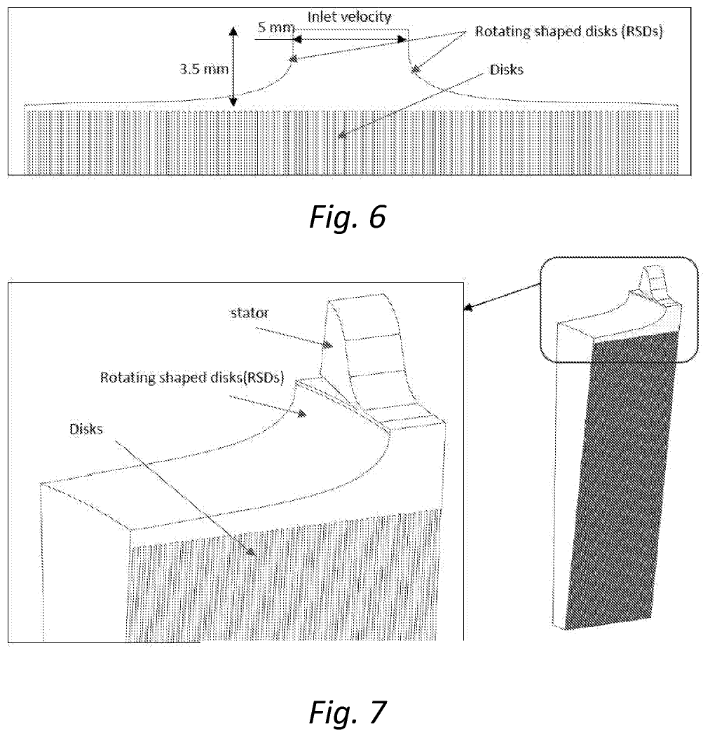

FIG. 6 shows the 2D axis geometry used for computational fluid dynamics (CFD) simulation;

FIG. 7 shows the 3D geometry used for the CFD simulation;

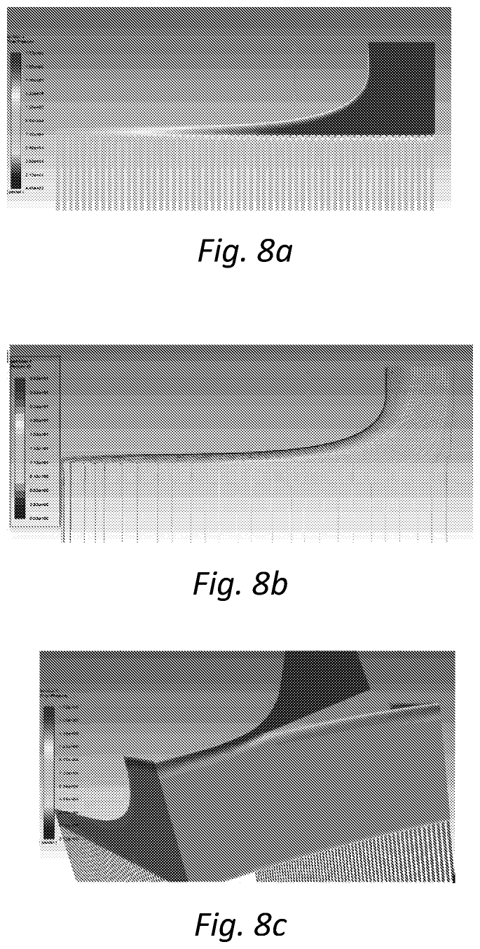

FIGS. 8a-8c show the CFD results for FIG. 1 setup;

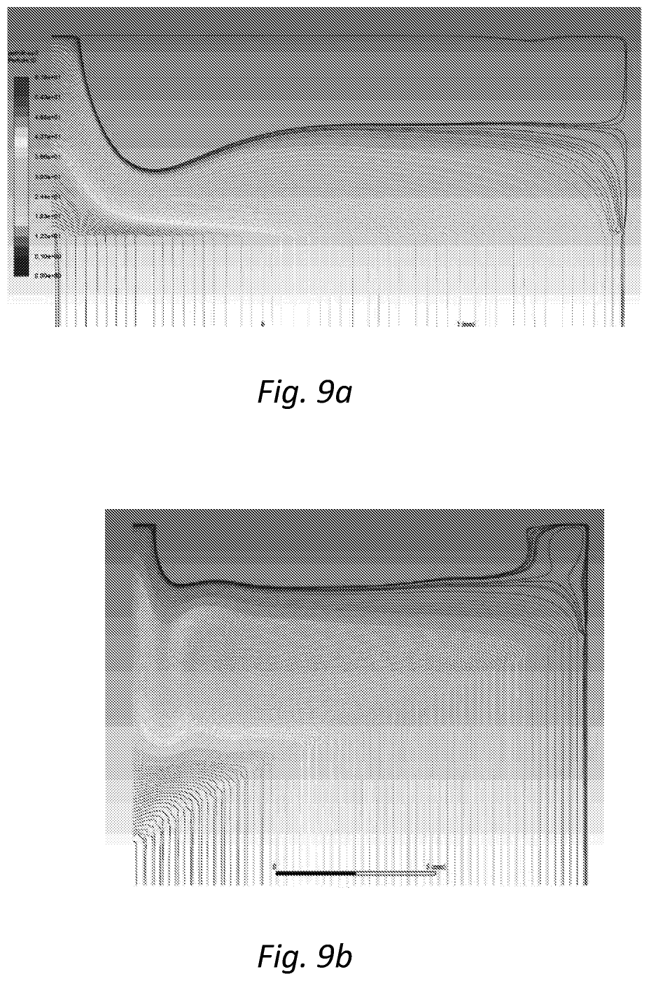

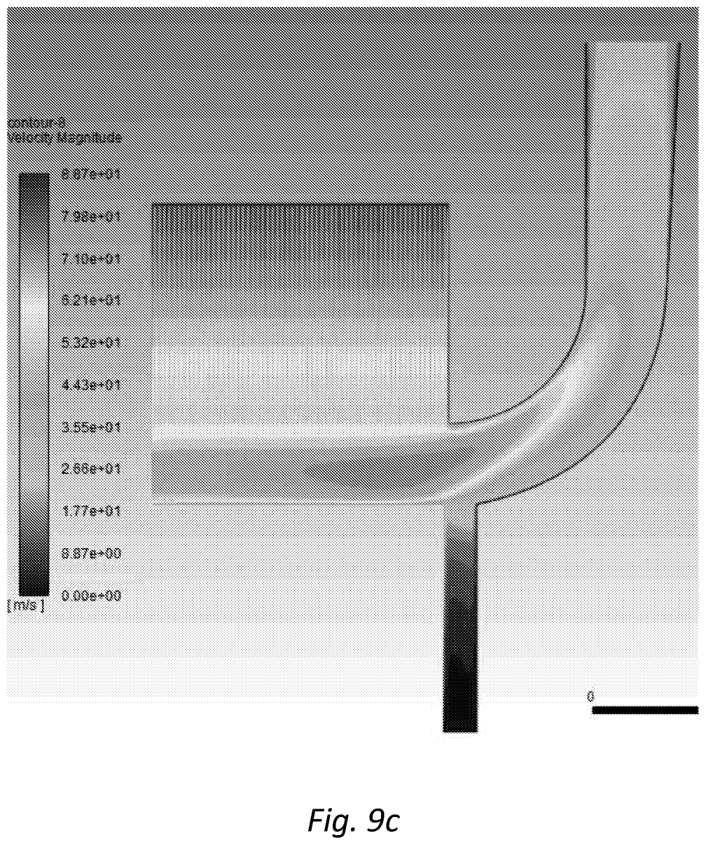

FIGS. 9a-9c show the CFD results for the configuration of FIG. 2;

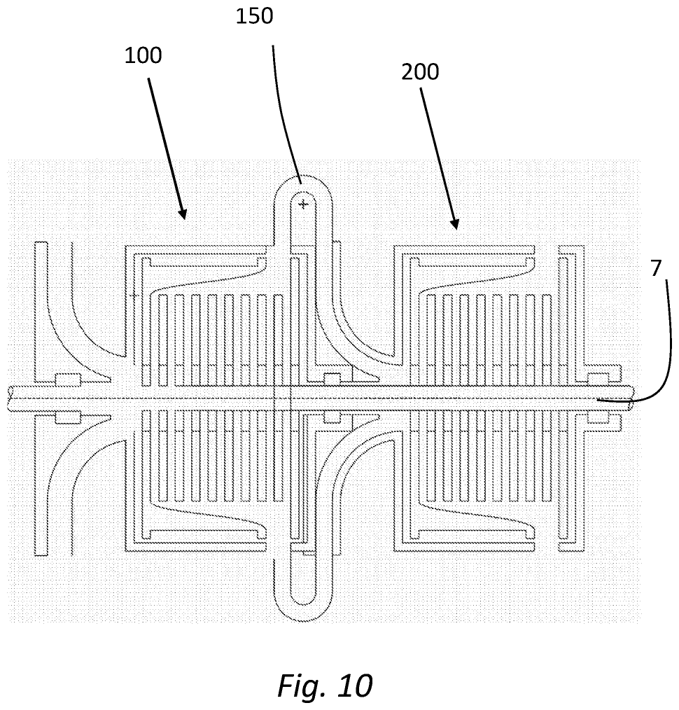

FIG. 10 shows a possible arrangement of a multistage turbine;

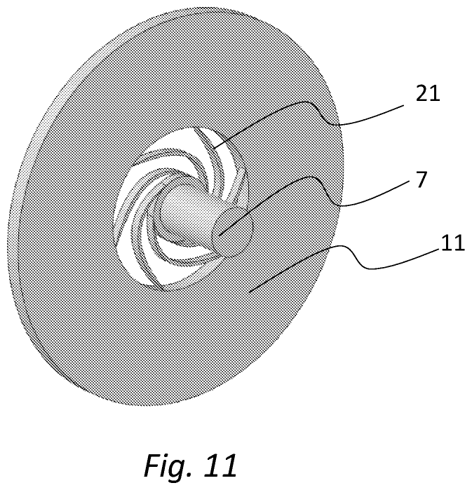

FIG. 11 shows a possible embodiment of a second energy exchange member provided in the fluid zone with the lowest relative speed.

However, the invention is not limited to the embodiments presented herein and the description is not intended to limit any of the other possible variations of the invention.

The following description relates to the mode of operation of the turbine with reference to the figures in the drawings, i.e., the mode of operation in which the fluid flow expands and produces useful work on the shaft. However, a similar principle of operation applies in case of compressor mode, i.e. when the rotating shaft is driven in the opposite direction of rotation by an external power source and the machine converts the mechanical energy into fluid energy.

Referring to the figures, and more specifically to FIGS. 1a-1d, there is shown a high level schematic diagram of BTM according to an embodiment of the present invention. The components shown in these figures are provided with axial symmetry about the axis of rotation X. FIG. 1a shows the BTM with a fixed casing or housing 6, 10, which can be of any particular configuration and also made in several parts. This housing 10 incorporates a stator 20, a device which supplies fluid to the rotor assembly. The stator may be of any particular configuration known in the art. The rotor unit comprises a shaft 7 on which one or more thin discs 3 are mounted. The discs 3 are separated by gaps, of constant thickness between disc and disc or variable. The discs 3 can be of any particular shape or material or manufacturing method known in the art. One or two rotating shaped disks or RSDs (Rotating Shaped Disks) 11 are placed at the end of one side (FIG. 1d) or both sides of the disks 3 as shown in FIG. 1a. The rotor aperture formed by the RSDs 11 receives fluid from the stator through the stator aperture 20 as described above. The inner contour of the RSDs forms the rotating distribution chamber 17 as shown in FIG. 4(a). The discs 3 have at least one central opening 5 from which the fluid exits axially. The fluid then passes through the axial vanes 21 that are stationary (connected to the housing 10) or fixed to the RSDs 11 or shaft 7. The housing parts 10 and 6 form a radial diffuser system or RDS with or without guide 22. The fluid from the central openings 5 of the disks travels to the RSD 11. The RSD outlet can possibly be connected to further static pressure recovery devices such as collectors or volutes with variable or constant section known in the art.

FIG. 1b shows the three-dimensional view with cross section. This allows for a better understanding of the components described above. Shaft 7 is supported on one or more bearings 8 known in the art.

The various embodiments of the present invention shown in FIG. 1a are applicable to one or more BTM exhaust systems (in the case of BT) and intake systems (in the case of BC).

FIG. 1c shows the various embodiments of the present inventions shown in FIG. 1a, applied to single exhaust system configuration. The specific embodiments shown in FIGS. 1c and 1d herein are merely illustrative of the invention and do not limit the scope of the invention. In the configuration shown in FIG. 1c, two RSDs 11 can be incorporated symmetrically. The fixed casing 12 is modified so as to have a single discharge configuration while the discs have the same radial dimension and are reciprocally equally spaced; the distribution chamber has a symmetrical configuration with respect to the central disc of the pack of discs 3. Still in FIG. 1c a further feature of the invention can be observed in which at least one of the distribution members 11 has at least one face exposed towards a radially internal surface of the stator housing which face is provided with at least one radially internal groove 13 cooperating with the facing portion of the stator housing 27 to form a sealed labyrinth to limit fluid losses or maximize the portion of fluid which stator channel 20 is directed towards the disks 3.

In the configuration shown in FIG. 1d, an RSD 11 may be used on one side and a thicker disc 14 with the outside diameter equal to or greater than or less than the RSD on the other side. The housing or stationary housings 27 and 15 are modified to incorporate the RSDs 11 and/or thicker disc 14.

The BTM-related embodiments of the present invention shown in FIG. 1a-1d can be arranged in a single stage or in several stages as shown in FIG. 10 and/or series or parallel depending on the application and the energy produced/required. The embodiments of the present invention shown in FIG. 1 applied to BT and BC can be on the same shaft or on a different shaft in applications where turbochargers or turbopumps or the like are implemented.

Referring to FIG. 2, a high-level schematic diagram of BTM according to another embodiment of the present invention is shown. The components shown in FIG. 2a-2c are axisymmetric. FIG. 2a shows a BTM with a fixed case or housing 2 which can be of any particular configuration and in several parts. This housing incorporates the stator 22, a device which supplies fluid to the rotor assembly (1, 3, 7 and/or 23). Stator 22 may be of any particular configuration known in the art. The rotor unit consists of a shaft 7 on which one or more thin discs 3 are mounted. The discs 3 are separated by a constant or mutually variable gap. The discs 3 may be of any particular design or material or manner of manufacture known in the art. The rotating shaped discs or RSDs 1 and 9 are connected to the shaft 7 preferably in the center of the rotor as shown in FIG. 2a. The opening formed by the RSDs 1 and 9 receives the fluid from the stator, which accelerates it according to a tangential and axial direction. The inner contour of the RSD forms the rotating distribution chamber 16 as shown in FIG. 3a. The discs 3 have a central opening 5 from which the fluid exits axially. The fluid then flows through the axial blades 23 attached to the RSDs 1 or 9. The stationary housing portions 4 and 6 form a radial diffuser system with or without guide blades 24; the fluid from the central openings 5 of the discs travels towards this radial diffuser system, the outlet of which is optionally connected to further static pressure recovery devices such as collectors or volutes with variable or constant section known in the art.

FIG. 2b shows the three-dimensional view with cross section of the machine of FIG. 2a. Shaft 7 is supported on one or more bearings or the like 8 known in the art.

The various embodiments of the present invention shown in FIG. 2a are applicable to one or more exhaust systems (in the case of LV) and intake systems (in the case of BC) of boundary layer turbomachinery. FIG. 2c shows the various embodiments of the invention shown in FIG. 2a, applied to single exhaust system configuration. The specific embodiments shown in FIG. 2c herein are merely illustrative of the invention and do not limit its scope.

FIG. 2c shows embodiments of the present invention applied to the single BT discharge. In the configuration shown in FIG. 2c, an RSD 1 may be incorporated on one side of the reed valve pack 3. The fixed casing 2 is modified to have a single discharge configuration.

For these embodiments as well of the present invention relating to the turbomachinery shown in FIG. 2a-2c, the turbomachine can be made in a single stage or multistage and/or series or parallel according to the application and the energy produced/required. The embodiments of the present invention shown in FIG. 2a2c applied to BT and BC may be on the same shaft or on a different shaft in applications where turbochargers or the like are implemented.

FIGS. 3a-3c show some more specific details of embodiments of the inventions presented in FIGS. 2a-2c. As shown in FIG. 3a, the rotating distribution chamber 16 is present between the discs 3 and the RSDs 1 and 9. This distribution chamber can be of different shape depending on the design of the RSDs 1 and 9 or the discs 3. FIGS. 3a-3c show possible configurations of the rotating distribution chamber formed by modifying the RSDs 1 and 9; in FIG. 3a the discs have the same diameter and the RSDs 1 and 9 are designed to create a cylindrical distribution chamber, i.e. the distance between the discs and the casing is almost constant for each of the discs. FIG. 3b shows another possible configuration of rotating distribution chamber formed by varying the RSDs 1 and 9 keeping the outer diameter of the discs 3 uniform and the size of the RSDs 1 axially variable while FIG. 3c shows a swirl chamber configuration formed by changing the outer diameter of the discs 3 that grows in the path from RSD 9 to RSD 1.

FIG. 4 shows some more specific details of embodiments of the inventions presented in FIGS. 1a-1c. As shown in FIG. 4a, the rotating distribution chamber, in this figure identified by the reference number, 17 is formed between the discs 3 and the RSDs 11. This rotating distribution chamber can have any desired shape depending on the design of the RSDs 11 or the discs 3. FIG. 4b shows the introduction of one or more flow dividers 18, which divide the rotating distribution chamber into several sections: these flow dividers can be fixed or rotating.

In a possible variant of the invention, the turbomachine comprises two rotating distribution chambers 19a and 19b, shown in FIG. 4c in a symmetrical configuration with respect to a plane orthogonal to the axis of rotation and passing through the median point of the axial dimension of all rotor discs. In this embodiment, the external diameter of the center of the discs 3 has been modified and the same axial-symmetrical profile of the RSDs 11 has been maintained.

FIG. 5 relates to the exhaust system having fluid outlet from the center of the discs towards the radial diffuser system of FIG. 1a-1d and FIG. 2a-2c. FIG. 5 shows the meridian view of the central discs having variable aperture 5 up to the inlet of the radial diffuser system, expanding from the axially central disc to the axially peripheral discs. The central openings 5 of the disc have an axially variable radial height which can be linear or of any other desired shape on the basis of the fluid speed and the number of discs 3. In one possible embodiment, the shape of the opening of the discs is such that the speed of the flow remains constant in the discharge direction.

As a general overview of operation for the embodiments shown in FIG. 1a-1d and FIG. 2a-2c, in BT mode, the high velocity fluid from the stator travels to the aperture created by the RSDs in the rotating distribution chamber 17 as shown by the arrows in FIG. 1a-1d and FIG. 2a-2c. In the rotating distribution chamber, there is fluid with a high rotational speed. This highspeed rotating fluid then enters the space between the 3 discs. Energy transfer occurs between the fluid and the discs, and also between the fluid and the RSDs by tangential forces. The fluid then leaves the set of discs with a central hole flowing through the central opening 5 of the discs 3. The fluid leaving the central opening 5 of the discs still has residual kinetic energy which is then recovered preferably using an exhaust system with radial diffuser, which can comprise one or more convection vanes of the fluid known in the art in the path towards the discharge (not shown in the figure).

As a general overview of operation for embodiments of the present inventions shown in FIG. 1a-1d and FIG. 2a-2c, in BC mode, the fluid enters the central opening of the discs by suction created by the rotating shaft. The fluid then travels through the space between the disks gaining energy from the disks. The fluid leaves the discs with a high peripheral speed. The rotating distribution chamber acts as a collector of fluid from the disc spaces at the periphery. The fluid leaving the port of the RSDs can then be passed through diffusers known in the art to convert the kinetic energy into pressure energy.

With reference to FIG. 10, a possible embodiment of a turbo-machine in accordance with the present invention is presented in which two machines 100 and 200 are connected on the same axis 7, the two machines being connected by means of a fitting 150 which connects the fluid entering one machine with the fluid exiting the other. In this case the individual machines 100 and 200 have a configuration of the rotating distribution chamber of the type already illustrated in FIG. 1d but, obviously, it is possible to use other punctual configurations and not necessarily the same configuration for the two machines 100 and 200. Although the two-stage type configuration (which can be generalized to more than two stages) is known, this combination assumes significant technical value when applied to Tesla machines made more performing according to one or more of the characteristics claimed by the invention. The bivalence of the turbomachinery is also valid in this configuration since the same multistage configuration can be used as a compressor or as a turbine depending on the purposes for which the system is used.

FIG. 11 shows a possible specific embodiment of the discharge openings on the components of the rotor pack. Preferably this configuration is applied to at least one RSD but it can also be implemented in combination or as an alternative to the disks 3 constituting the rotor pack. The references used in FIG. 11 are consistent with those used in FIG. 1a.

It is noted the presence of a plurality of spiral connection spokes 21 which depart from the hub for connection to the shaft 7 towards the solid body of the rotating shaped disc 11; such spiral connections therefore define a plurality of discharge openings crossed by the fluid on its way from or towards the zone of relatively lower pressure. Advantageously, this shape allows to support the rotation of the disc at high speed (typical of this type of turbine) and further reduce the losses in the transit area of the flow in the axial direction.

In an alternative variant of the invention the multistage turbine comprises several turbomachines of which at least one operates in operating mode and at least one of said turbomachines works in driving mode. This embodiment of the turbo-compressor type preferably provides for the presence of a turbine which converts energy of a fluid into mechanical energy, which mechanical energy is used to accelerate a second fluid to which part of this mechanical energy is transferred. Clearly such an embodiment can find application in the real world only when the efficiencies of the individual machines are such that they can be combined while maintaining a non-negligible part of the work useful at the end of the sequence of turbomachines, or in the case where the output work is negative but is compensated by a net positive external contribution, for example from an electric motor keyed to the same rotating shaft. Advantageously, the present invention allows this application unlike traditional Tesla machines thanks to the significant improvement in performance which is obtained by applying the inventive concepts reported herein.

### CFD Results

2D and 3D computational fluid dynamics (CFD) analysis was performed to verify the effectiveness of the embodiments in the present inventions; only the operating mode of the turbine is considered.

Standard CFD approaches are used with ANSYS commercial software. A sensitivity analysis on the grid is performed to ensure that there are no significant changes in the output parameters. The k-w SST and Y+<1 s turbulence model is used for the rotor and walls present in the system. The real gas model is used to accurately predict machine performance.

Below are the details of the rotor used for the simulation:

| Fluid | Aria (real gas model) | |
|---|---|---|
| Disk number | 120 | |
| Disk external diameter | 120 | mm |
| Internal hole diameter | 60 | mm |
| Disk thickness | 0.1 | mm |
| Disk distance | 0.14 | mm |

CFD—Turbine mode without blades—configuration of FIG. 1 two exhausts.

In this case, the configuration shown in FIG. 1 is simulated in 2D and 3D. The 2D geometry comprises RSD, distribution chamber and discs (without exhaust system). The inlet condition is at uniform tangential and radial velocity components and the outlet at ambient pressure. FIG. 6 shows the 2D axis geometry used for the simulation.

The 3D geometry comprises RSDs and discs exactly the same as in the 2D simulation, except the stator is also used here. The 3D simulation is closer to the real working condition of the turbine. A conventional converging nozzle known in the art is used. FIG. 7 shows the 3D geometry used for the simulation.

The results of the calculations are shown in the following table (the efficiencies are of the adiabatic-isentropic type):

| | 2D-without stator | 3D- with stator |
|---|---|---|
| Nozzle number | — (Inlet with | 48 |
| | uniform speed) | |
| Inlet pressure, bar | — | 2.41 |
| Rotation speed, rpm | 37000 | 37000 |
| Inlet axial playG, mm | 5 | 5 |
| Mass flow, g/s | 28.6 | 33 |
| Power, W | 2110 | 1651 |
| Rotor-only efficiency, | 86 | 86 |
| total-total | | |
| Overall efficiency, | 84 | 80 |
| total-total, % | | |

The 2D simulation does not include the stator losses but preserves the stator-rotor interaction losses: for this reason the obtained isentropic efficiency is higher in 2D than in 3D. On the other hand, the 3D stator model (i.e. stator losses are included) predicts 80% of the overall efficiency. The difference in efficiency is due to the losses present inside the stator. Geometric optimization of the nozzle would minimize the difference between 2D and 3D efficiency.

The CFD simulation of the radial diffuser at the exhaust shows a significant improvement in performance, reducing the static pressure at the rotor exhaust by exploiting the residual kinetic energy. One of these analyzes is performed as shown in the attached FIG. 9c, for a disk pack of the Tesla rotor coupled to a radial exhaust system: about 80-85% of the kinetic energy at the rotor exhaust is converted into static pressure. This improves turbine efficiency by about 10 percentage points.

The results are very promising and the efficiency values predicted by the CFD analysis are far beyond what can be obtained in the state of the art. The CFD values in the literature have typically been found in the range of 50-60% recovery of kinetic energy under pressure: with the present invention we have already demonstrated values above 80% overall.

From what has been described it is clear that the instrument according to the invention achieves the preset purposes.

The object of the invention is susceptible to modifications and variations, all falling within the inventive concept expressed in the attached claims. All the details can be replaced by other technically equivalent elements, and the materials can be different according to the requirements, without departing from the scope of protection of the present invention.

Although the object has been described with particular reference to the accompanying figures, the reference numbers used in the description and in the claims are used to enhance the understanding of the invention and do not constitute any limitation to the claimed scope of protection.

The invention claimed is:

1. A reversible turbomachine configured to operate in turbine mode transforming energy of a fluid into mechanical energy or configured to operate in compressor mode for transforming mechanical energy into energy of the fluid, said reversible turbomachine comprising:
a rotor housing containing one or more members of a rotor, the rotor comprising a plurality of mutually spaced disks rotating about a rotation axis and coaxially arranged about a rotation shaft;
a primary stage for a flow of the fluid having high energy, communicating with the rotor housing via a statoric channel;
a secondary stage for the flow of the fluid in low energy state; and
a rotating distribution chamber for distributing said fluid to or from the rotor, said rotating distribution chamber being arranged in an internal space of the rotor housing and interposed between the statoric channel and at least part of said disks, said rotating distribution chamber being provided with at least one rotor opening for the flow of the fluid between the primary stage and the rotor.

2. The reversible turbomachine according to claim 1, wherein said rotating distribution chamber is arranged coaxially with the disks and rotates at a same angular speed as said disks.

3. The reversible turbomachine according to claim 1, wherein said rotating distribution chamber is delimited by a chamber wall which radially and at least partially surrounds the rotor, said chamber wall being formed by at least part of a radially internal surface of at least one distribution member, which rotates coaxially to the rotation shaft, preferably at a same angular speed as the disks.

4. The reversible turbomachine according to claim 3, wherein the at least one of said distribution members has a face exposed towards a radially internal surface of a stator housing, and wherein said face of the at least one distribution member is provided with at least one radially internal groove cooperating with a facing portion of the stator housing to form a sealed labyrinth limiting fluid losses.

5. The reversible turbomachine according to claim 1, wherein said rotating distribution chamber has a symmetrical or asymmetrical conformation with respect to a plane orthogonal to the rotation axis of the disks.

6. The reversible turbomachine according to claim 1, wherein the reversible turbomachine comprises two rotating distribution chambers arranged in a symmetrical configuration with reference to a plane orthogonal to the rotation axis and passing through a midpoint of an axial dimension of a totality of the disks of the rotor.

7. The reversible turbomachine according to claim 1, wherein a stator opening of the rotating distribution chamber is divided into two or more opening portions by one or more flow dividers.

8. The reversible turbomachine according to claim 1, wherein a stator opening of the rotating distribution chamber is provided in a direction having at least one axial component referred to the rotation axis of the rotor.

9. A multistage turbomachine comprising:
two or more turbomachines in accordance with claim 1,
wherein the same fluid flow passes over the two or more turbomachines arranged consecutively.

10. The multistage turbomachine according to claim 9, wherein at least two of the two or more turbomachines are mechanically connected between rotation shafts thereof.

11. The multistage turbomachine according to claim 9, wherein at least one of said two or more turbomachines operates in compressor mode and at least one of said two or more turbomachines works in turbine mode.
